(19) United States
(12) Patent Application Publication
(10) Pub. No.: US 2010/0147391 A1
(43) Pub. Date: Jun. 17, 2010

(54) APPARATUS AND METHOD FOR CONTROLLING A FLUID FLOWING THROUGH A PIPELINE

(75) Inventors: James R. Stoy, Houston, TX (US); Lee D. Rhyne, Cypress, TX (US)

Correspondence Address: CHEVRON CORPORATION, P.O. BOX 6006, SAN RAMON, CA, 94583-0806, US

(73) Assignee: CHEVRON U.S.A. INC

(21) Appl. No.: 12/334,139

(22) Filed: Dec. 12, 2008

(51) Int. Cl. G05D 7/06

(52) U.S. Cl. 137/2; 137/115.01; 137/109; 137/115.02

(57) ABSTRACT

An apparatus and method for controlling the passage of a multiple-phase fluid through a pipeline are provided. The apparatus can generally include a first tubular passage that defines an inlet and an outlet, and a valve that is fluidly positioned between the inlet and the outlet and configured to control the flow of fluid through the first tubular passage. A second tubular passage extends from a first position upstream of the valve to a second position downstream of the valve so that the second tubular passage is configured to receive fluid from the first tubular passage upstream of the valve and deliver the fluid to the first tubular passage downstream of the valve. The valve can be selectively controlled to an open configuration to allow gas in the fluid to flow through the first tubular passage while liquid accumulates in the second tubular passage and a closed configuration to direct gas in the fluid to flow through the second tubular passage and thereby deliver liquid accumulated in the accumulation volume as a slug through the outlet of the first tubular passage.

### BACKGROUND OF THE INVENTION

1. Field of the Invention

This invention relates to the control of fluids flowing through pipelines, such as for accumulating a liquid from a multiple-phase fluid in a pipeline and controllably delivering the liquid to flow as a slug through the pipeline.

2. Description of Related Art

Pipelines are commonly used to transport fluids of multiple phases. For example, a gas pipeline can be used to transport natural gas from a gas-producing wellhead to a handling facility. Some liquid, and possibly solids, can be generated with the gas, such that the fluid flowing through the pipeline is actually a multiple-phase fluid, e.g., a combination of gas, liquid, and solids. In some cases, the liquid and/or solids that are present in a flow of such a multiple-phase fluid tend to collect in the pipeline. The liquids and solids can accumulate throughout the pipeline, though accumulations are often more likely to occur at particular locations, e.g., at locations where the pipeline changes elevation, size, or other configuration.

Solids, typically small particles, accumulating in the pipeline can reduce the effective size of the pipeline and, in some cases, can restrict or block the flow of fluids. Solids can be removed by passing a mechanical device referred to as a pig through the pipeline to push the solids out of the pipeline. While pigging has been used effectively, such operations may require interruption to the flow of the fluid and may result in stuck pigs.

Liquids accumulating at a particular location in the pipeline can reach a critical magnitude, at which the liquid can become dislodged from its point of accumulation and travel as a coherent volume or “slug” of liquid driven by the flow of the gas through the pipeline. A liquid slug can travel through the pipeline in a piston-like fashion, at a velocity similar to that of the flowing gas. A liquid slug moving at the velocity of the gas can impose significant inertial loads on the pipeline and its support structures, especially wherever the pipeline changes direction. Due to the relatively large mass of the liquid, inertial loads resulting from the slug can be much greater than the loads that typically result from the flow of gas. Thus, pipelines designed to handle the loads normally expected in dry gas service may be insufficient for handling the inertia of a liquid slug.

The phenomenon can be particularly evident when the pipeline rises in the direction of flow (i.e., the fluid flows uphill) as the nominal velocity of gas is insufficient to induce the continuous flow of more-dense liquid uphill. For example, in a pipeline that delivers natural gas from a sub-sea wellhead to a handling facility on the sea surface, the liquids may accumulate at the relatively low elevations of the pipeline before flowing to the higher elevations of the pipeline. The liquids may accumulate sufficiently to block, or otherwise interfere with, the flow of gas through the pipe. As gas continues to flow into the pipeline upstream of the liquid accumulation, the pressure typically rises upstream of the accumulation until the pressure is sufficient to dislodge the liquid and deliver the liquid as a coherent slug through the pipeline. The slug, and the high pressure gas upstream of the slug, may exert large stresses on the pipeline, the pipeline support structure, and the handling facility.

Slugging can be particularly evident in pipelines that carry natural gas from mature offshore gas fields, where depletion of the gas resource in the field often results in lower overall gas production rates, lower gas velocity, and higher liquid production rates. Under these conditions, larger accumulations of liquid may be likely to occur before the critical magnitude is achieved and the dislodging of a slug is triggered. Indeed, pipelines that have operated trouble-free for decades can develop slugging problems as the gas producing field becomes mature and approaches depletion. Larger slugs may increase the severity of inertial forces imposed upon pipeline structural supports. In this regard, damage to pipelines and their support structures have been documented, particularly in sub-sea pipelines where the lines rise to the shore.

Conventional methods for avoiding slugging in pipelines include the use of equipment designed to “catch” a slug and remove it from the pipeline upstream of a point where the pipeline is vulnerable to slug-induced damage. For example, the slug can be collected in a vessel that is disposed in a serial configuration in the pipeline. This “slug catcher” approach necessitates special equipment for collecting and disposing of the liquids removed from the pipeline. While such equipment has been used successfully, this is typically a costly, complex, and inconvenient requirement. Further, such conventional equipment for catching a slug in this manner is typically designed as a device having a limited liquid capacity. In some cases, an unusually large slug that is accumulated under abnormal conditions could exceed the capacity of the slug catcher and a large fraction of the slug could remain in the pipeline, possibly inflicting damage to the pipeline and equipment downstream of the slug catcher.

Thus, a continued need exists for an improved apparatus and method for reducing the likelihood of damage or other problems resulting from the accumulation of solids and liquids in a pipeline and the flow of large liquid slugs through the pipeline.

### SUMMARY OF THE INVENTION

The embodiments of the present invention generally provide apparatuses and methods useful for controlling the flow of fluids through pipelines, such as for accumulating a liquid from a multiple-phase fluid in a pipeline and controllably delivering the liquid to flow as a slug through the pipeline.

According to one embodiment, a slug control apparatus includes a first tubular passage that defines an inlet and an outlet. A valve is fluidly positioned between the inlet and the outlet and configured to control the flow of fluid through the first tubular passage. A second tubular passage extends from a first position upstream of the valve to a second position downstream of the valve so that the second tubular passage is configured to receive fluid from the first tubular passage upstream of the valve and deliver the fluid to the first tubular passage downstream of the valve. The second tubular passage defines an accumulation volume therein that is configured to be positioned lower than the first tubular passage so that liquid in the fluid accumulates in the accumulation volume. For example, the first tubular passage can be a substantially straight tube, and the second tubular passage can define a U-shaped configuration that hangs below the first tubular passage. The valve is configured to be selectively controlled between an open configuration and a closed configuration. In the open configuration, the valve allows gas in the fluid to flow through the first tubular passage while liquid accumulates in the second tubular passage. In the closed configuration, the valve directs gas in the fluid to flow through the second tubular passage and thereby delivers liquid accumulated in the accumulation volume as a slug through the outlet of the first tubular passage.

In some cases, the apparatus includes a controller that is configured to control the valve between the open and closed configurations and to thereby alternately allow liquid to accumulate in the second tubular passage and deliver slugs of the liquid from the second tubular passage through the outlet of the first tubular passage. A sensor can be configured to detect liquid accumulated in the second tubular passage, and the controller can be configured to close the valve when the sensor detects a predetermined volume of liquid in the second tubular passage. The controller can be configured to open the valve after the controller closes the valve and after the sensor subsequently detects that the liquid has been delivered from the second tubular passage. Alternatively, the controller can be configured to open the valve after a predetermined time interval after the controller closes the valve.

A baffle can be provided in first tubular passage of the apparatus and configured to direct liquid that is on an inside surface of the first tubular passage to flow into the second tubular passage.

According to another embodiment, a method for controlling the passage of a multiple-phase fluid through a pipeline includes providing a first tubular passage having an inlet configured to receive the fluid, an outlet configured to deliver the fluid therefrom, and a valve fluidly positioned between the inlet and the outlet. A second tubular passage is provided, extending from a first position upstream of the valve to a second position downstream of the valve. For example, the first tubular passage can be provided as a substantially straight tube, and the second tubular passage can be provided as a tube having U-shaped configuration. In particular, the tubular passages can be provided as a replacement portion of an existing pipeline, e.g., by removing a portion of a pipeline and replacing the portion with the first tubular passage. A valve is selectively adjusted between an open configuration and a closed configuration so that, in the open configuration, the valve allows gas in the fluid to flow through the first tubular passage to the outlet while liquid accumulates in the second tubular passage, and, in the closed configuration, the valve directs gas in the fluid to flow through the second tubular passage and thereby deliver liquid accumulated in the accumulation volume as a slug through the outlet of the first tubular passage. For example, liquid can be delivered from the second tubular passage as a slug having a predetermined volume.

In some cases, the valve is adjustably controlled repeatedly between the open and closed configurations, thereby alternately allowing liquid to accumulate in the second tubular passage and delivering slugs of the liquid from the second tubular passage through the outlet of the first tubular passage. The valve can be automatically closed upon detecting a predetermined volume of liquid in the second tubular passage. The valve can be automatically opened upon detecting that the liquid has been delivered from the second tubular passage or after a predetermined time interval after the valve is closed.

A baffle can be provided for directing liquid on an inside surface of the first tubular passage to flow into the second tubular passage.

The apparatuses and methods of the present invention can generally be used for purposes such as generating slugs having volume or mass that is no greater than a predetermined maximum to thereby reduce the likelihood of larger slugs that might otherwise form in the pipeline. In addition or alternative, the apparatuses and methods can generally be used to generate slugs for performing pigging operations, e.g., to collect solids and liquids that may have accumulated throughout the pipeline and transport the accumulated solids or liquids through the pipeline with the slug. It is appreciated that the apparatuses and methods can be used with or without another device for catching slugs in the pipeline and/or removing the slugs from the pipeline. In fact, in some cases, all of the liquid and/or solid in the fluid in the pipeline is delivered by the apparatus through the pipeline with the gas.

### BRIEF DESCRIPTION OF THE DRAWINGS

Having thus described the invention in general terms, reference will now be made to the accompanying drawings, which are not necessarily drawn to scale, and wherein:

FIG. 1 is a schematic diagram illustrating a system including a pipeline for transporting a fluid from a fluid source to a fluid receiver and a slug control apparatus for controlling the passage of the fluid through the pipeline according to one embodiment of the present invention;

FIGS. 2-6 are schematic diagrams illustrating the slug control apparatus of the system of FIG. 1, illustrating a sequence of operations for collecting and delivering slugs according to one embodiment of the present invention;

FIG. 7 is a schematic diagram illustrating the slug control apparatus of the system of FIG. 1, illustrating the flow of an annular-mist flow regime therethrough;

FIGS. 8 and 9 are schematic diagrams illustrating a slug control apparatuses according to other embodiments of the present invention, each including a baffle for removing liquid from the inside surface of a first tubular passage and directing the liquid to flow into a second tubular passage; and

FIG. 10 is a schematic diagram illustrating a slug control apparatus according to another embodiment of the present invention, in which the first tubular passage defines a portion having an increased diameter so that the fluid slows therein and liquid in an annular-mist flow can settle to the bottom of the first tubular passage in a stratified flow.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

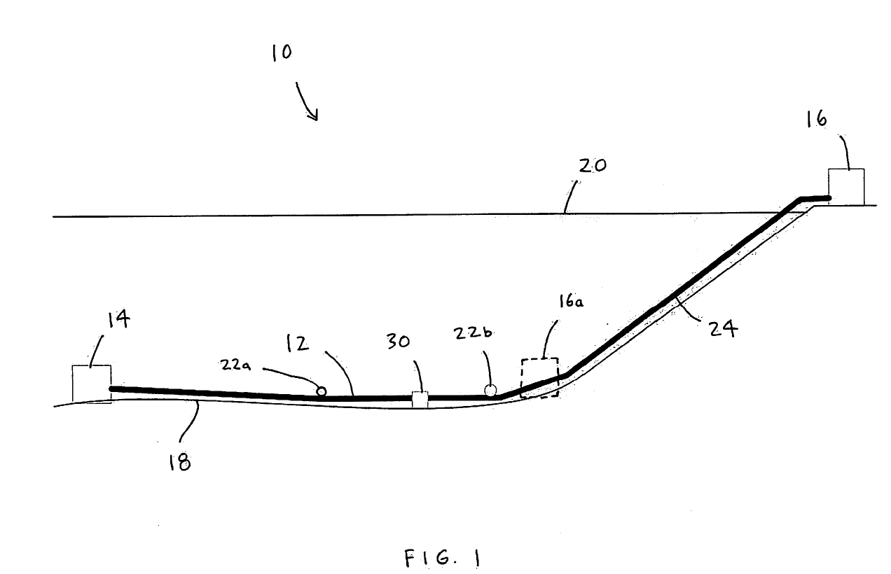

Referring now to the drawings and, in particular, to FIG. 1, there is schematically shown a system 10 that includes a pipeline 12 for transporting a fluid from a fluid source, such as a subsea wellhead 14 that provides a flow of a natural gas, to a fluid receiver, such as handling facility 16 that receives the natural gas for subsequent processing, storage, and/or distribution. In some cases, the pipeline 12 can be configured to deliver the fluid in a non-linear and/or non-horizontal path, e.g., as shown in FIG. 1, from the wellhead 14 located on the sea floor 18 to the handling facility 16 located at the sea surface 20. In other embodiments, the handling facility 16 can be (or can include) subsea equipment, such as processing equipment that is located on the seafloor 18 as indicated by reference numeral 16a. The fluid produced from the wellhead 14 and delivered through the pipeline 12 is typically a multiple-phase fluid, i.e., a combination of a gas and liquid, which may also contain solids, such as particles in the liquid and/or gaseous phases. In particular, the fluid can be a combination of natural gas, water and/or natural gas condensates, and solid particles. Alternatively, the fluid can be a combination of natural gas, oil, and water. In some cases, the system 10 can also include detection devices 22a, 22b that detect system parameters, such as the presence of liquid or solid accumulations in the pipeline 12, the occurrence of slugging throughout the pipeline 12, other aspects of the flow through the pipeline 12, and the like.

The system 10 also includes a slug control apparatus 30 that can be used to selectively control the passage of the fluid through the pipeline 12. The slug control apparatus 30 is located between the fluid source and the fluid receiver, typically at a position upstream of any locations where significant slugging is likely to occur. For example, as shown in FIG. 1, the slug control apparatus 30 can be located upstream of the significant ascent 24 of the pipeline 12 from the sea floor 18 to the sea surface 20. The detection devices 22a, 22b can be located upstream and/or downstream of the slug control apparatus 30.

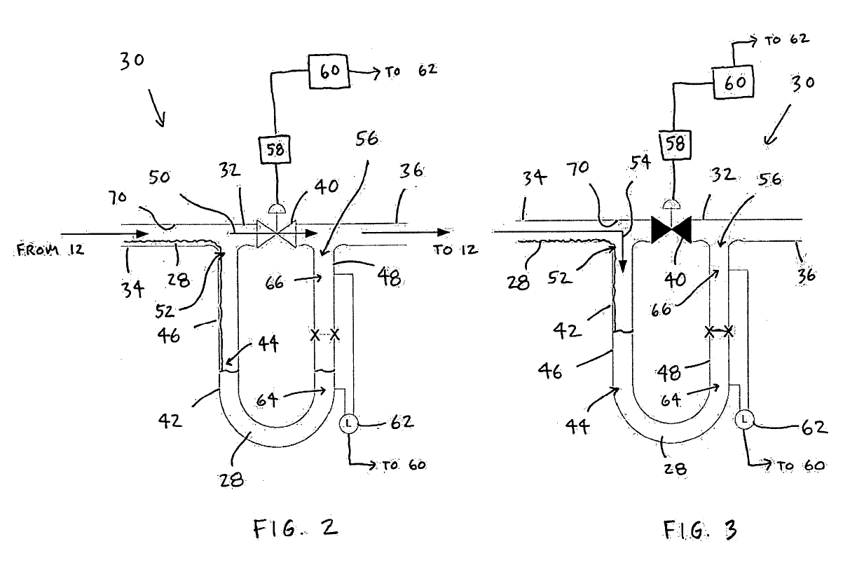

The slug control apparatus 30 is further illustrated in FIGS. 2-6. As illustrated in FIG. 2, the slug control apparatus 30 includes a first tubular passage 32, which defines an inlet 34 at a first end of the apparatus 30 for receiving the fluid into the apparatus 30, and an outlet 36 at an opposite end for delivering the fluid from the apparatus 30. The first tubular passage 32 can be a pipe, such as a straight pipe, and can be installed in place of a short, linear segment of the pipeline 12, e.g., in a new pipeline installation or as a replacement portion that is spliced into an existing pipeline 12.

A valve 40 is fluidly positioned between the inlet 34 and the outlet 36 and configured to control the flow of fluid through the first tubular passage 32. The term “valve” is used herein to refer to any device for adjusting the flow of fluid through the first tubular passage 32. As shown in FIG. 2, the valve 40 can be a conventional stop valve, such as a globe valve, gate valve, butterfly valve, ball valve, plug valve, or needle valve. The valve 40 is generally configured to be selectively controlled between an open configuration (FIG. 2) and a closed configuration (FIG. 3). It is appreciated that the valve 40 in the open configuration will allow the passage of fluid through the first tubular passage 32, and the valve 40 in the closed configuration will restrict (or prevent entirely) the passage of fluid therethrough.

A second tubular passage 42 is configured to deliver a flow around the valve 40 and thereby bypass the valve 40, i.e., by receiving fluid from the first tubular passage 32 upstream of the valve 40 and delivering the fluid to the first tubular passage 32 downstream of the valve 40. In this regard, the second tubular passage 42 extends from a first position that is upstream of the valve 40 to a second position that is downstream of the valve 40. The second tubular passage 42 defines an internal accumulation volume 44 therein that is configured to be positioned lower than the first tubular passage 32 so that liquid 28 that is present in the fluid tends to accumulate in the accumulation volume 44. In particular, as shown in FIG. 2, the second tubular passage 42 can define a U-shaped configuration (a “sump”) having two legs 46, 48 so that, with the first tubular passage 32 in a generally horizontal configuration, the second tubular passage 42 hangs below the first tubular passage 32 to an elevation lower than the first tubular passage 32 and the local portion of the pipeline 12.

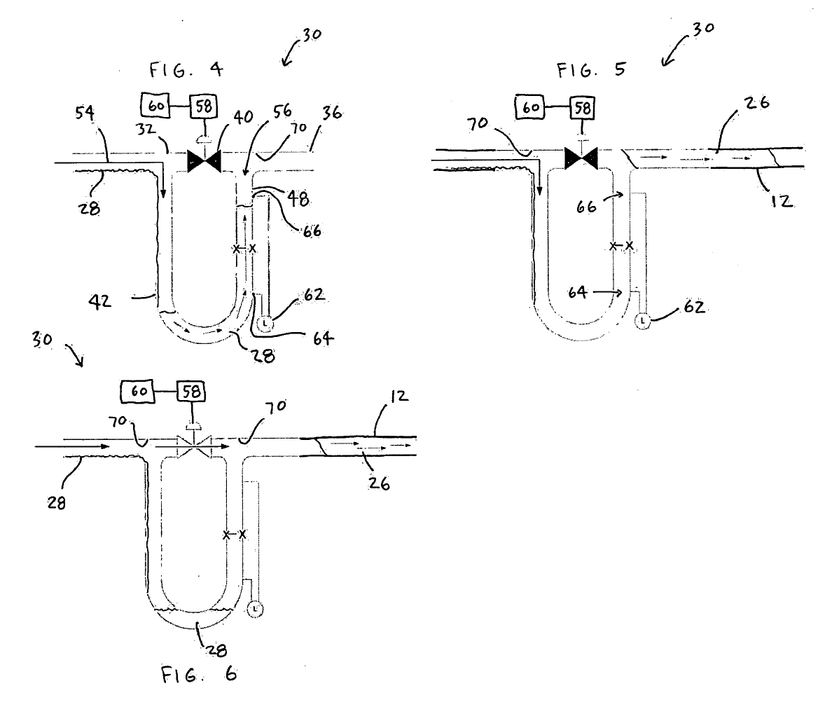

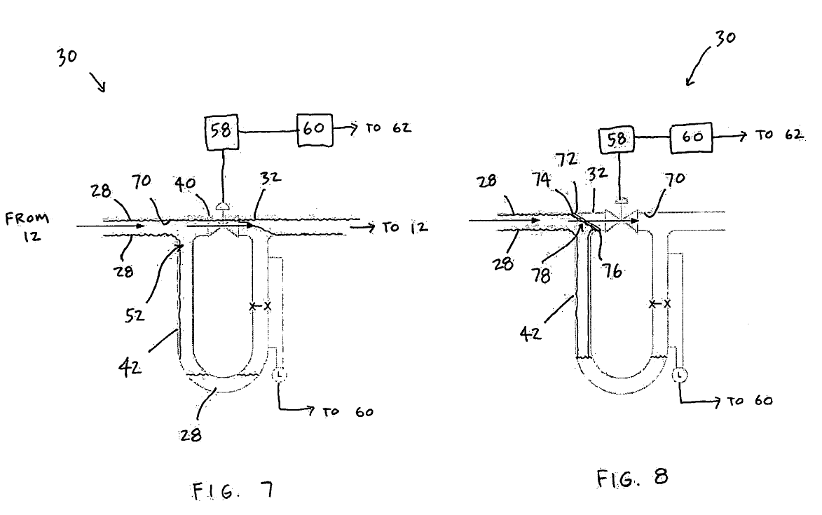

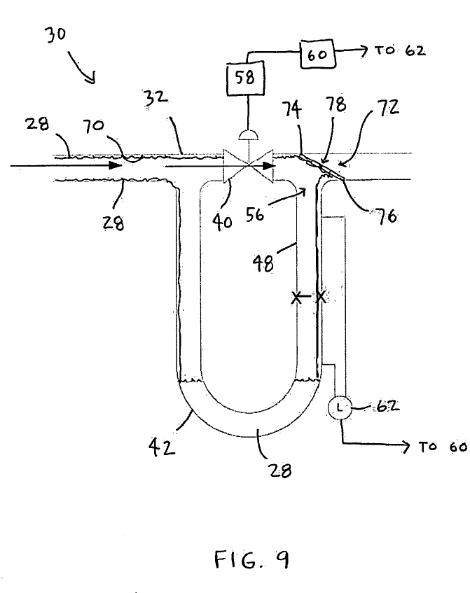

With the valve 40 in its open configuration, fluid can flow through the first tubular passage 32 and flow in the path 50, as shown in FIG. 2. Due to the configuration of the second tubular passage 42, liquid 28 in the fluid that is heavier than the gas in the fluid will tend to flow into the second tubular passage 42. For example, with the U-shaped second tubular passage 42 configured so that the legs 46, 48 hang below the pipeline 12, liquid 28 flowing near the bottom of the pipeline 12 at the inlet 34 of the apparatus 30 will fall by gravity into an inlet 52 defined by the upstream leg 46 of the second tubular passage 42 and collect in the accumulation volume 44. On the other hand, with the valve 40 in its closed configuration, the flow of gas through the first tubular passage 32 is restricted (or prevented entirely) by the valve 40, and the gas flowing into the apparatus 30 will instead be directed to flow through the second tubular passage 42 in the path 54 as shown in FIGS. 3 and 4. As the gas is made to flow through the second tubular passage 42, the gas will push the accumulated liquid 28 in the second tubular passage 42 through an outlet 56 defined by the downstream leg 48 and thereby deliver accumulated liquid 28 from the accumulation volume 44 as a slug 26 through the outlet 36 and through the pipeline 12 (FIG. 5).

The valve 40 can be controlled manually or automatically. In this regard, an actuator 58 can be configured to open and close the valve 40, and a controller 60 can be configured to selectively operate the actuator 58 and thereby control the valve 40 between its open and closed configurations. The controller 60 can be located with the apparatus 30, or the controller 60 can be located remotely, e.g., at the handling facility 16 or other surface location accessibly by a human operator, and in communication with the apparatus 30. The controller 60 can operate according to a predetermined schedule of operations, the controller 60 can operate according to the automatic detection of various system parameters, and/or the controller 60 can be triggered by a manual control input from a human operator. For example, the controller 60 can be configured to deliver a slug 26 through the pipeline 12 upon a manual input when a human operator determines that a cleaning operation should be performed in the pipeline 12 and/or automatically whenever sufficient liquid 28 has accumulated in the apparatus 30, whenever liquid accumulations occur at other locations in the pipeline 12, and/or whenever solid accumulations occur throughout the pipeline 12.

In one embodiment, the apparatus 30 can include one or more sensors 62 configured to detect liquid accumulated in the second tubular passage 42. The sensor(s) 62 can be in communication with the controller 60, e.g., via a wired connection, a wireless connection, or a mechanical connect, and the controller 60 can be configured to close the valve 40 (e.g., by providing an operative signal to the actuator 58) when the sensor 62 detects a predetermined volume of liquid in the second tubular passage 42. As illustrated, a single sensor 62 can be configured to monitor the fluid in the second tubular passage at a plurality of detection points 64, 66 to determine if liquid is present at the level of the various detection points 64, 66.

After the controller 60 closes the valve 40, the controller 60 can be configured to re-open the valve 40 (e.g., by providing an operative signal to the actuator 58), e.g., when the sensor 62 detects that the liquid 28 has been delivered from the second tubular passage 42. Alternatively, the controller 60 can be configured to re-open the valve 40 after a predetermined time interval has elapsed, e.g., a time interval that is determined to be sufficient to allow the flow of fluid into the apparatus 30 and through the second tubular passage 42 to clear the liquid slug 26 from the second tubular passage 42. In this way, the apparatus 30 (e.g., as controlled by the controller 60) can alternately allow liquid to accumulate in the second tubular passage 42 and deliver slugs 26 of the liquid from the second tubular passage 42 through the outlet 36 of the first tubular passage 32.

For example, with the valve 40 open as shown in FIG. 2, the gas in the fluid flows through the first tubular passage 32 and through the pipeline 12 to the fluid receiver. Liquid (and, possibly, solid particles) 28 in the fluid separate from the gas and fall into the second tubular passage 42 where the liquid accumulates. When the sensor 62 detects a predetermined volume of liquid in the second tubular passage 42, e.g., by detecting the rise of the liquid level 29 to the first detection point 64, the controller 60 issues a signal to the actuator 58 to thereby close the valve 40, as shown in FIG. 3. As shown in FIGS. 4 and 5, with the valve 40 closed, fluid (including gas) that flows into the apparatus 30 is directed through the second tubular passage 42. When the pressure of the gas flowing into the apparatus 30 is sufficient, the gas forces the accumulated liquid through the second tubular passage 42 and up into the first tubular passage 32, where the accumulated liquid flows as a slug 26 through the outlet 36 of the apparatus 30 and through the pipeline 12 toward the receiver. When the sensor 62 detects that the liquid has been removed from the second tubular passage 42 (FIG. 5), e.g., by detecting the absence of liquid 28 at the first detection point 64 and/or the second, higher detection point 66, the controller 60 issues a signal to the actuator 58 to thereby open the valve 40. FIG. 6, illustrates the apparatus 30 after the valve 40 has been re-opened so that gas again flows through the first tubular passage 32 and liquid 28 accumulates in the second tubular passage 42. When a predetermined amount of liquid 28 is detected in the second tubular passage 42, the valve 40 can be closed again to deliver another slug 26 of liquid through the pipeline 12, and the operation can repeat indefinitely. As noted, in other embodiments, the operation of the valve 40 can be triggered by other parameters of the apparatus 30 or system 10 and/or the valve 40 can be operated according to a predetermined schedule.

In some cases, the apparatus 30 can be used to collect liquid and deliver the liquid as discrete, coherent slugs 26 of controlled size so that the liquid does not accumulate elsewhere in the pipeline 12 into larger slugs that might damage the system 10. For example, upon detection by detector 22a of a long slug upstream of the slug control apparatus 30, the controller 60 can cause the apparatus 30 to sequentially (a) close the valve 40 to deliver liquid therefrom and empty the apparatus 30, (b) open the valve 40 to collect and retain liquid in the second tubular passage 42, e.g., as much liquid as can be held in the accumulation volume 44, (c) allow the rest of the slug to pass with the valve 40 open, (d) allow some amount of gas to pass with the valve 40 open, and (e) return to operation (a) and repeat, thereby allowing long slugs to be broken up for better handling downstream.

In addition, or alternative, the apparatus 30 can be used to collect liquid and deliver the liquid as discrete, coherent slugs 26 of controlled size so that the slugs 26 perform a pig-like function in the pipeline 12. That is, as each slug 26 travels through the pipeline 12, the slug 26 can collect small amounts of liquid or solid debris that has accumulated in the pipeline 12 so that the accumulated liquids or solids are transported through the pipeline 12 with the slug 26 to the receiver. In fact, if uncontrolled slugging does not present a significant problem in the pipeline 12, the apparatus 30 can be used to provide this cleaning function at regular intervals or only when accumulations are detected to keep the pipeline 12 clean and clear of liquid or solid deposits that might interfere with flow therethrough. For example, the controller 60 can be configured to receive a signal from the detection device 22b indicative of an accumulation in the pipeline 12, and, when the detection device 22b detects an accumulation of solids and/or liquids in the pipeline, the controller 60 can generate a slug so that the slug removes the solids and/or liquids from the pipeline 12 by carrying the solids and/or liquids to the handling facility 16.

It is appreciated that the apparatus 30 can be optimized for the flow that occurs in a particular pipeline 12 and for the particular needs of the pipeline 12. For example, the dimensions and configurations of the first and second tubular passages 32, 34 can be provided to allow a predetermined amount of liquid to accumulate before being delivered as a slug 26 of a predetermined size (or a slug 26 that has a volume or mass of less than a predetermined size). Further, the location of the detection points 64, 66 and the operation of the controller 60 and valve 40 can be configured, calibrated, or otherwise adjusted to provide slugs 26 of predetermined volume or mass through the pipeline 12. In this way, the maximum volume or mass of a slug 26 can be limited to a value that can be accommodated by the system 10 without serious threat to the integrity of the pipeline 12 and its support structure.

The timing of the operation of the apparatus 30 can be optimized so that slugs 26 are delivered at intervals appropriate for the needs of the pipeline 12, and the operation of the apparatus 30 can be modified to adjust to the changing conditions of the fluid source, fluid receiver, or pipeline 12. For example, if the pipeline 12 develops a risk for accumulation of large liquid slugs, the apparatus 30 can be used to automatically and constantly collect liquid and deliver the liquid as slugs 26 having smaller sizes that can be accommodated in the pipeline 12. On the other hand, if the pipeline 12 develops a risk for accumulation of solids, the apparatus 30 can be used to collect liquid and deliver the liquid as slugs 26 of sufficient size for cleaning the pipeline 12, typically at less frequent intervals of operation, which may be triggered manually (e.g., by a human operator) or automatically (e.g., according to a predetermined schedule or when accumulations are detected in the pipeline 12 by one or more detection devices 22a, 22b or otherwise).

If large slug formation does not need to be prevented in the pipeline 12, e.g., if the fluids contains little liquid and/or the liquid tends to maintain a laminar flow throughout the pipeline 12 without forming large slugs, the valve 40 may be kept open even if the second tubular passage 42 is filled with liquid. In that case, with the second tubular passage 42 full of liquid, additional liquids flowing through the apparatus 30 will tend to flow through the first tubular passage 32 with the gas.

In any case, the valve 40 can be operated according to routines that are different and/or more complex than those described above. For example, in some cases, it may be desired to deliver a slug 26 having a volume that is less than that of the liquid accumulated in the second tubular passage 42. Thus, the valve 40 can be closed to initiate the flow of a slug 26 from the second tubular passage 42, and the valve 40 can then be re-opened before all of the liquid has left the second tubular passage 42. In some cases, it may be desired to deliver several slugs 26 in quick succession through the pipeline 12, e.g., to perform a cleaning operation. Thus, the valve 40 may be closed and re-opened quickly so that the slugs 26 are provided, with a gap therebetween determined by the duration of the valve 40 in the open position between the slugs 26. The second tubular passage 42 may be emptied for each successive slug 26, or the valve 40 can be re-opened before the second tubular passage 42 is emptied to form smaller slugs 26.

In some cases, the flow regime in the pipeline 12 is such that the liquid 28 is distributed as a film that completely wets the interior surface of the pipeline 12 and the interior surface 70 of the first tubular passage 32, as shown in FIG. 7. For this type of flow regime (e.g., an annular-mist flow), much of the liquid 28 flowing with the gas might bypass the inlet 52 of the second tubular passage 42 and instead flow directly through the first tubular passage 32 with the gas, possibly accumulating as a slug elsewhere in the pipeline 12. Such an occurrence of liquids bypassing the second tubular passage 42 can be mitigated, e.g., by providing a baffle 72 in the apparatus 30 that is configured to direct liquid 28 that is flowing on the inside surface 70 of the first tubular passage 32 to flow into the second tubular passage 42, as shown in FIG. 8. The baffle 72 can include an elliptic disk-shaped plate that is positioned and fixed in the first tubular passage 32 so that the outer perimeter of the baffle 72 is in contact with the inside surface 70 of the passage 32. As illustrated, the baffle 72 can be positioned within the first tubular passage 32 so that that the disk “leans” upstream, i.e., the baffle 72 is angled relative to the transverse direction of the passage 32 so that the upper edge 74 of the baffle 72 is further upstream than the lower edge 76 of the baffle 72. The lower edge 76 of the baffle 72 can be positioned immediately downstream of the inlet 52 to the second tubular passage 42, and the upper edge 74 of the baffle 72 can be positioned against the inside surface 70 at the top of the pipeline 12.

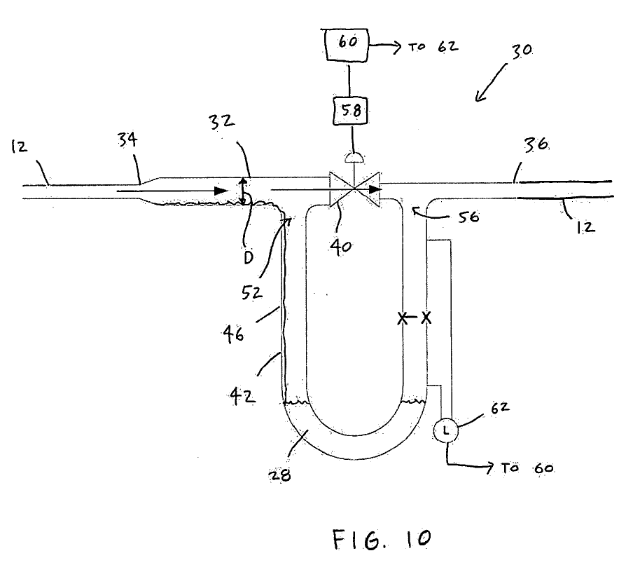

The baffle 72 defines at least one orifice 78, e.g., a round hole at the center of the baffle 72, as shown in FIG. 8. As fluid flows through the apparatus 30, gas in the fluid passes through the orifice 78 and continues flowing through the first tubular passage 32 to the outlet 36. Liquid 28 that is flowing along the insider surface 70 of the first tubular passage 32 tends to be stripped off the inside surface 70 by the baffle 72. The leaning or angled configuration of the baffle 72 can result in a downward velocity component being imparted to the liquid flowing at the top of the first tubular passage 32, thereby directing the liquid downward into the second tubular passage 42. In some cases, the performance of the baffle 72 may be enhanced by positioning it a small distance downstream of the illustrated position, or the baffle 72 may perform better if positioned immediately downstream of the outlet 56 defined by the downstream leg 48 of the second tubular passage 42, e.g., as shown in FIG. 9.

Other baffle types and configurations can be provided. For example, in some cases, the baffle 72 may be integrally formed as a part of the apparatus 30. Alternatively, by providing an increased diameter D (i.e., a diameter that is greater than the diameter of the pipeline 12 immediately upstream) in the first tubular passage 32 or the pipeline 12 upstream of the inlet 52 of the upstream leg 46 of the second tubular passage 42, the flow velocity may be reduced to allow an annular-mist flow to subside to stratified flow wherein most or all of the liquid separates from the gas and flows as a coherent stream along the bottom of the pipe, so that the liquid will fall into the inlet 52 of the second tubular passage 42 by the effect of gravity, as shown in FIG. 10. Other conventional methods can also be used to encourage liquid in the fluid to separate from the gas and fall into either the inlet 52 or the outlet 56 of the second tubular passage 42. Further, if liquid bypasses the apparatus 30 and accumulates in the pipeline 12 at a location downstream of the apparatus 30, the liquid accumulations can be collected and swept away by generating a slug 26 with the apparatus 30 and allowing the slug 26 to flow through the pipeline 12 to perform a cleaning operation to collect the other accumulations throughout the pipeline 12.

In some embodiments, additional devices can be provided in the apparatus 30 for altering the flow therethrough, such as one or more valves for adjusting the flow of fluids through the first and second tubular passages 32, 42 or the like.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1 A slug control apparatus for controlling the passage of a fluid through a pipeline, the fluid including gas and liquid, the apparatus comprising:
a first tubular passage defining an inlet and an outlet;
a valve fluidly positioned between the inlet and the outlet and configured to control the flow of fluid through the first tubular passage; and
a second tubular passage extending from a first position upstream of the valve to a second position downstream of the valve such that the second tubular passage is configured to receive fluid from the first tubular passage upstream of the valve and deliver the fluid to the first tubular passage downstream of the valve, the second tubular passage defining an accumulation volume therein configured to be positioned lower than the first tubular passage such that liquid in the fluid accumulates in the accumulation volume,
wherein the valve is configured to be selectively controlled to an open configuration to allow gas in the fluid to flow through the first tubular passage while liquid accumulates in the second tubular passage and a closed configuration to direct gas in the fluid to flow through the second tubular passage and thereby deliver liquid accumulated in the accumulation volume as a slug through the outlet of the first tubular passage.

2. An apparatus according to claim 1 wherein the first tubular passage is a substantially straight tube and the second tubular passage defines a U-shaped configuration.

3. An apparatus according to claim 1, further comprising a controller configured to control the valve between the open and closed configurations and to alternately allow liquid to accumulate in the second tubular passage and deliver slugs of the liquid from the second tubular passage through the outlet of the first tubular passage.

4. An apparatus according to claim 3, further comprising a sensor configured to detect liquid accumulated in the second tubular passage, wherein the controller is configured to close the valve when the sensor detects a predetermined volume of liquid in the second tubular passage.

5. An apparatus according to claim 4 wherein the controller is configured to open the valve after the controller closes the valve and after the sensor subsequently detects that the liquid has been delivered from the second tubular passage.

6. An apparatus according to claim 4 wherein the controller is configured to open the valve after a predetermined time interval after the controller closes the valve.

7. An apparatus according to claim 1, further comprising a baffle configured to direct liquid on an inside surface of the first tubular passage to flow into the second tubular passage.

8. A method for controlling the passage of a multiple-phase fluid through a pipeline, the method comprising:
providing a first tubular passage having an inlet configured to receive the fluid, an outlet configured to deliver the fluid therefrom, and a valve fluidly positioned between the inlet and the outlet;
providing a second tubular passage extending from a first position upstream of the valve to a second position downstream of the valve; and
selectively adjusting the valve between an open configuration and a closed configuration such that, in the open configuration, the valve allows gas in the fluid to flow through the first tubular passage to the outlet while liquid accumulates in the second tubular passage, and, in the closed configuration, the valve directs gas in the fluid to flow through the second tubular passage and thereby deliver liquid accumulated in the accumulation volume as a slug through the outlet of the first tubular passage.

9. A method according to claim 8 wherein the step of providing the first tubular passage comprises providing the first tubular passage as a substantially straight tube and wherein the step of providing the second tubular passage comprises providing the second tubular passage having a U-shaped configuration.

10. A method according to claim 8 wherein the steps of providing the first and second tubular passages comprise removing a portion of a pipeline and replacing the portion with the first tubular passage.

11. A method according to claim 8, further comprising controlling the valve between the open and closed configurations and alternately allowing liquid to accumulate in the second tubular passage and delivering slugs of the liquid from the second tubular passage through the outlet of the first tubular passage.

12. A method according to claim 13, wherein the valve is automatically closed upon detecting a predetermined volume of liquid in the second tubular passage.

13. A method according to claim 12, wherein the valve is automatically opened upon detecting that the liquid has been delivered from the second tubular passage.

14. A method according to claim 12, wherein the valve is automatically opened after a predetermined time interval after the valve is closed.

15. A method according to claim 8, further comprising providing a baffle for directing liquid on an inside surface of the first tubular passage to flow into the second tubular passage.

16. A method according to claim 8, further comprising delivering liquid from the second tubular passage as a slug having a predetermined volume.
